(19) United States
(12) Patent Application Publication
(10) Pub. No.: US 2024/0012264 A1
(43) Pub. Date: Jan. 11, 2024

(54) DISPLAY DEVICE FOR VEHICLE

(71) Applicant: YAZAKI CORPORATION, Tokyo (JP)

(72) Inventors: Takafumi Yamase, Susono-shi (JP); Jun Shihaku, Susono-shi (JP)

(21) Appl. No.: 18/335,112

(22) Filed: Jun. 14, 2023

(30) Foreign Application Priority Data
Jul. 11, 2022 (JP) 2022-111013

(51) Int. Cl. G02B 27/28; G02B 27/01

(52) U.S. Cl. CPC G02B 27/286; G02B 27/0101; G02B 2027/0118

(57) ABSTRACT

A display device for a vehicle includes: a display, a polarization switching unit, a reflector, and a controller. The polarization switching unit includes a wave plate that can cause emission light of the display to be emitted while changing a polarization direction thereof, and a drive device that uses an electric motor as a driving source and can rotate the wave plate between a position of not using polarizing sunglasses and a position of using polarizing sunglasses. When a command is given to switch a required visual recognition mode to the mode of not using polarizing sunglasses or the mode of using polarizing sunglasses, the controller supplies an exciting current to the electric motor to rotate the wave plate to the rotational position of the required visual recognition mode, and interrupts the exciting current flowing through the electric motor thereafter.

### CROSS-REFERENCE TO RELATED APPLICATION(S)

The present application claims priority to and incorporates by reference the entire contents of Japanese Patent Application No. 2022-111013 filed in Japan on Jul. 11, 2022.

### BACKGROUND OF THE INVENTION

### 1. Field of the Invention

The present invention relates to a display device for a vehicle.

### 2. Description of the Related Art

Conventionally, a display device for a vehicle that displays information provided to an occupant in a compartment is mounted on a vehicle. For example, as the display device for a vehicle, there is known what is called a head-up display device that causes projection light related to display information to be projected toward a windshield or a combiner, and causes the projection light to be reflected from the windshield and the like toward the occupant to cause the occupant to visually recognize the display information as a virtual image. In such a type of the display device for a vehicle, reflected light containing S polarized light as a principal component is reflected from the windshield and the like toward the occupant. However, the S polarized light is typically cut by polarizing sunglasses. Due to this, when the occupant is wearing polarizing sunglasses, visibility of the virtual image is lowered such that luminance of the virtual image is lowered as compared with a case in which the occupant is not wearing the polarizing sunglasses. For example, Japanese Patent Application Laid-open No. 2019-108088 and Japanese Patent Application Laid-open No. 2013-57897 described below disclose a technique in which the display device for a vehicle switches a polarization direction of emission light of a display between the time of using polarizing sunglasses and the time of not using polarizing sunglasses, and reflects reflected light of a polarized component that can be transmitted through the polarizing sunglasses at the time when the polarizing sunglasses are used.

In the conventional display device for a vehicle, a wave plate on which the emission light is incident is driven to rotate by an electric motor to switch the polarization direction of the emission light of the display between the time of using polarizing sunglasses and the time of not using polarizing sunglasses. Due to this, there is a cause for concern about increase in power consumption of the display device for a vehicle. Thus, for example, in the display device for a vehicle disclosed in Japanese Patent Application Laid-open No. 2019-108088, luminance of a preferred polarized component appropriate for the time of using polarizing sunglasses or the time of not using polarizing sunglasses is increased while luminance of a polarized component inappropriate for the time of using polarizing sunglasses or the time of not using polarizing sunglasses is lowered to suppress increase in power consumption. However, there is room for improvement in the conventional display device for a vehicle in terms of suppressing increase in power consumption.

### SUMMARY OF THE INVENTION

Thus, the present invention aims at providing a display device for a vehicle that may suppress increase in power consumption.

In order to solve the above mentioned problem and achieve the object, a display device for a vehicle according to one aspect of the present invention includes a display configured to emit, as display light, display information to be visually recognized as a virtual image by an occupant in a compartment; a polarization switching unit configured to emit emission light from the display while switching a polarization direction between a mode of not using polarizing sunglasses in which the occupant is not using polarizing sunglasses and a mode of using polarizing sunglasses in which the occupant is using polarizing sunglasses; a reflector configured to directly or indirectly receive the emission light from the polarization switching unit, and reflect the emission light toward an eye box as a visible range for a virtual image of the occupant; and a controller configured to control operation of the display and the polarization switching unit, wherein the polarization switching unit comprises: a wave plate configured to be able to emit emission light of the display while changing a polarization direction; and a drive device using an electric motor driven and controlled by the controller as a driving source and configured to be able to rotate the wave plate between a position of not using polarizing sunglasses in the mode of not using polarizing sunglasses and a position of using polarizing sunglasses in the mode of using polarizing sunglasses, causes transmitted light containing an S polarization component as a principal component to be emitted from the wave plate at the position of not using polarizing sunglasses, and causes transmitted light containing a P polarization component as a principal component to be emitted from the wave plate at the position of using polarizing sunglasses, and, when a command is given to switch a required visual recognition mode to the mode of not using polarizing sunglasses or the mode of using polarizing sunglasses, the controller supplies an exciting current to the electric motor to rotate the wave plate to a rotational position in the required visual recognition mode, and interrupts the exciting current flowing through the electric motor thereafter.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a display device for a vehicle according to an embodiment;

FIG. 2 is a perspective view illustrating a polarization switching unit;

FIG. 3 is a perspective view of viewing the polarization switching unit from a different angle;

FIG. 4 is an exploded perspective view illustrating the polarization switching unit;

FIG. 5 is a flowchart for explaining operation of the display device for a vehicle according to the embodiment;

FIG. 6 is a flowchart for explaining origin return control and rotational position control to a position of not using polarizing sunglasses;

FIG. 7 is a flowchart for explaining rotational position control to a position of using polarizing sunglasses;

FIG. 8 is a time chart illustrating an example of control in a case in which an ignition is turned off in a mode of using polarizing sunglasses;

FIG. 9 is a time chart illustrating an example of control in a case in which the ignition is turned off in a mode of not using polarizing sunglasses;

FIG. 10 is a time chart illustrating an example (modification) of control in a case in which the ignition is turned off in the mode of using polarizing sunglasses; and

FIG. 11 is a time chart illustrating an example (modification) of control in a case in which the ignition is turned off in the mode of not using polarizing sunglasses.

### DETAILED DESCRIPTION OF THE PREFERRED EMBODIMENTS

The following describes an embodiment of a display device for a vehicle according to the present invention in detail based on the drawings. The present invention is not limited to the embodiment.

### EMBODIMENT

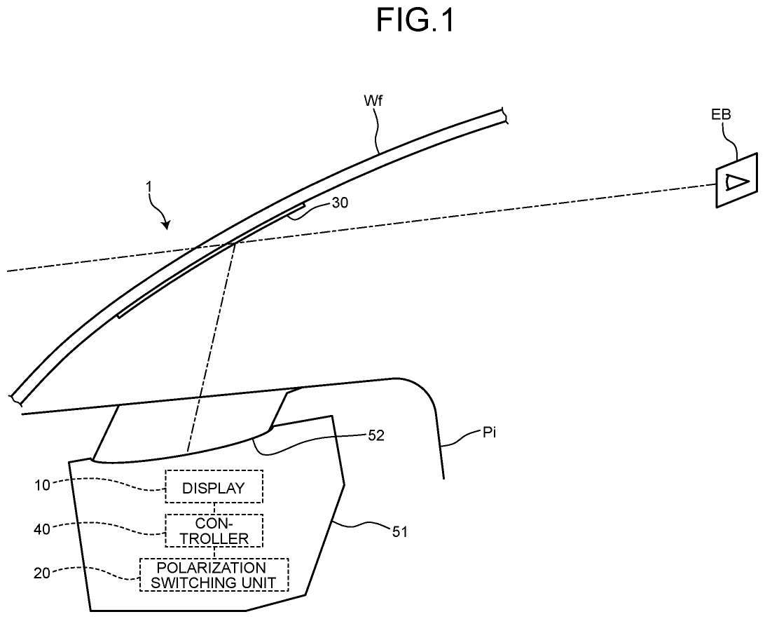

The following describes one embodiment of the display device for a vehicle according to the present invention based on FIG. 1 to FIG. 11.

The reference numeral 1 in FIG. 1 denotes the display device for a vehicle according to the embodiment. The display device 1 for a vehicle is what is called a head-up display device that displays information provided to an occupant in a compartment of a vehicle (such as an automobile) as a virtual image.

The display device 1 for a vehicle causes projection light related to display information to be reflected by a windshield and the like of the vehicle toward the occupant to cause the occupant to visually recognize a virtual image of the display information. Herein, a P polarization component is hardly reflected by the windshield as compared with an S polarization component, so that a principal component of reflected light toward the occupant is S polarized light. On the other hand, a main purpose of polarizing sunglasses that may be used by the occupant is to cut the S polarized light. Due to this, luminance of the virtual image is lowered at the time of using the polarizing sunglasses as compared with the time of not using the polarizing sunglasses. Thus, the display device 1 for a vehicle is configured as described below, and visibility of the virtual image at the time of using the polarizing sunglasses is improved by reducing a difference in luminance of the virtual image between the time when the occupant is not using the polarizing sunglasses and the time when the occupant is using the polarizing sunglasses.

The display device 1 for a vehicle includes a display 10 that emits, as display light, display information to be visually recognized as a virtual image by the occupant in the compartment; a polarization switching unit 20 that causes emission light from the display 10 to be emitted while switching a polarization direction between a mode of not using polarizing sunglasses in which the occupant is not using the polarizing sunglasses and a mode of using polarizing sunglasses in which the occupant is using the polarizing sunglasses; and a reflector 30 that directly or indirectly receive the emission light from the polarization switching unit 20, and reflects the emission light toward an eye box EB as a visible range of the virtual image for the occupant (FIG. 1). The display device 1 for a vehicle further includes a controller 40 that controls operation of the display 10 and the polarization switching unit 20 (FIG. 1).

The display device 1 for a vehicle includes a housing 51 housing the display 10, the polarization switching unit and the controller 40 inside, and a transparent cover 52 that closes an opening of the housing 51 (FIG. 1). The housing 51 is housed in an instrument panel Pi in the compartment in a state in which the cover 52 is exposed (FIG. 1). In the display device 1 for a vehicle, the emission light from the polarization switching unit 20 is directly or indirectly emitted to the outside of the instrument panel Pi via the cover 52 to be projected on the reflector 30 that is present ahead.

For example, the display 10 is configured to cause emission light of a light source (not illustrated) as backlight to be incident on a back surface, and to cause display light corresponding to the incident light from the back surface to be emitted from a front surface. For example, as the display 10, a light transmissive Thin Film Transistor Liquid Crystal Display (TFT liquid crystal) or the like is used. The display 10 displays, for example, image information such as characters, numerals, and figures as display information. The controller 40 controls the display 10 to execute display control for the display information.

For example, the reflector 30 is a windshield (herein, a front windshield Wf) itself. In this case, the windshield (front windshield Wf) as the reflector 30 directly or indirectly receives emission light from the polarization switching unit 20, and reflects the emission light from the windshield (front windshield Wf) toward the eye box EB.

Alternatively, the reflector 30 may be disposed on the windshield (front windshield Wf). The reflector 30 is formed as a half mirror that directly or indirectly receives emission light from the polarization switching unit 20 by a reflection surface to be reflected toward the eye box EB, and causes light from the outside of the vehicle to be emitted toward the occupant side. For example, the reflector 30 is formed in a film shape along a curved surface shape of the windshield (front windshield Wf), and is bonded to a wall surface on a vehicle interior side of the windshield with a bonding agent. Alternatively, the reflector 30 may be formed in a film shape along the curved surface shape of the windshield (front windshield Wf), and encapsulated in the windshield as laminated glass together with an interlayer. The reflector 30 may also be a coat that is coated by being applied to the wall surface on the vehicle interior side of the windshield (front windshield Wf).

The reflector 30 may also be a combiner that is arranged to be closer to the occupant than the windshield (front windshield Wf).

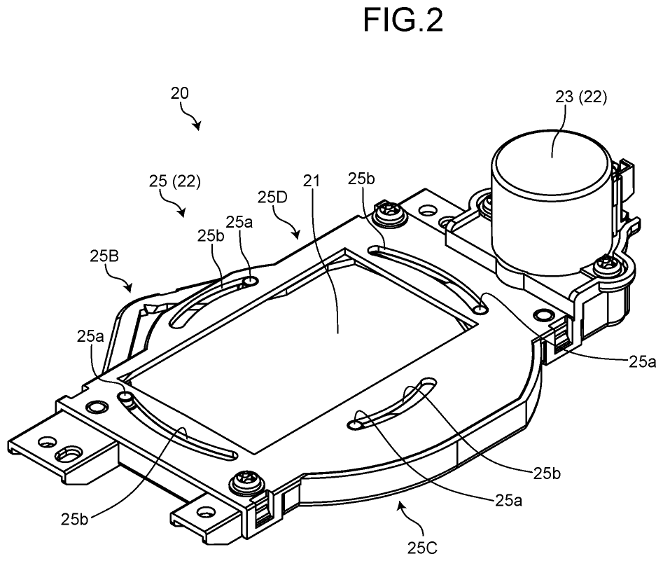

The polarization switching unit 20 includes a wave plate 21 that can change a polarization direction of emission light of the display 10 to be emitted, and a drive device 22 that can cause the wave plate 21 to rotate between a position of not using polarizing sunglasses in a mode of not using polarizing sunglasses and a position of using polarizing sunglasses in a mode of using polarizing sunglasses (FIG. 2 to FIG. 4). The polarization switching unit 20 may directly direct emission light from the wave plate 21 to the reflector 30, or may reflect the emission light from the wave plate 21 by a reflection member such as a magnifying mirror to indirectly direct the emission light to the reflector 30.

The polarization switching unit 20 causes transmitted light containing an S polarization component as a principal component to be emitted from the wave plate 21 at the position of not using polarizing sunglasses, and causes transmitted light containing a P polarization component as a principal component to be emitted from the wave plate 21 at the position of using polarizing sunglasses. That is, the polarization switching unit 20 causes projection light containing the S polarization component as a principal component to be projected on the reflector 30 when the rotational position of the wave plate 21 is the position of not using polarizing sunglasses while causing projection light containing the P polarization component as a principal component to be projected on the reflector 30 when the rotational position of the wave plate 21 is the position of using polarizing sunglasses.

Thus, the emission light of the display 10 that has been incident is transmitted through the wave plate 21 so that the principal component of projection light (emission light from the polarization switching unit 20) to be projected on the reflector 30 is the S polarization component when the rotational position is the position of not using polarizing sunglasses. The emission light of the display 10 that has been incident is then transmitted through the wave plate 21 so that the principal component of projection light (emission light from the polarization switching unit 20) to be projected on the reflector 30 is the P polarization component when the rotational position is the position of using polarizing sunglasses.

The wave plate 21 is well-known in this kind of technical field, and a half-wave plate is used herein.

For example, in a case in which the emission light of the display 10 is S polarized light, the rotational position of the wave plate 21 the fast axis of which is aligned with a polarization direction of the emission light of the display 10 is the position of not using polarizing sunglasses. The emission light of the display 10 is transmitted through the wave plate 21 while keeping the polarization direction when the rotational position is the position of not using polarizing sunglasses. Due to this, the projection light containing the S polarization component as a principal component is emitted from the polarization switching unit 20 to the reflector 30 when the rotational position of the wave plate 21 is the position of not using polarizing sunglasses.

The fast axis of the wave plate 21 is deviated from the polarization direction of the emission light of the display 10 by 45 degrees when the wave plate 21 is rotated from the position of not using polarizing sunglasses by 45 degrees, so that the emission light of the display 10 that has been incident is rotated by an angle of two times 45 degrees (90 degrees) to be emitted as transmitted light of P polarization. Due to this, projection light containing the P polarization component as a principal component is emitted from the polarization switching unit 20 to the reflector 30 when the wave plate 21 is rotated from the position of not using polarizing sunglasses by 45 degrees. Thus, the rotational position of the wave plate 21 rotated from the position of not using polarizing sunglasses by 45 degrees is the position of using polarizing sunglasses.

In a case in which the principal component of the emission light of the display 10 is not the S polarization component, arrangement of the wave plate 21 at the position of not using polarizing sunglasses may be replaced with the following arrangement. The fast axis of the wave plate 21 is deviated from the polarization direction of the emission light of the display 10 by a predetermined angle θ, and the polarization direction of the emission light of the display is rotated by an angle of two times θ (20) to cause the rotational position at which the transmitted light of S polarization is emitted to be the position of not using polarizing sunglasses. Due to this, the projection light containing the S polarization component as a principal component is emitted from the polarization switching unit to the reflector 30 when the rotational position of the wave plate 21 is the position of not using polarizing sunglasses.

The fast axis of the wave plate 21 is deviated from the polarization direction of the emission light of the display 10 by θ+45 degrees when the wave plate 21 is rotated from the position of not using polarizing sunglasses by 45 degrees, so that the emission light of the display 10 that has been incident is rotated by an angle of two times θ+45 degrees (2 θ+90 degrees) to be emitted as transmitted light of P polarization. Due to this, projection light containing the P polarization component as a principal component is emitted from the polarization switching unit 20 to the reflector 30 when the wave plate 21 is rotated from the position of not using polarizing sunglasses by 45 degrees. Thus, the rotational position of the wave plate 21 rotated from the position of not using polarizing sunglasses by 45 degrees is the position of using polarizing sunglasses.

That is, regarding the wave plate 21, even if the position of not using polarizing sunglasses is set to be any of the positions, the projection light containing the S polarization component as a principal component is emitted from the polarization switching unit 20 toward the reflector 30 at the position of not using polarizing sunglasses. Due to this, the display device 1 for a vehicle can enable the occupant not wearing polarizing sunglasses to visually recognize a virtual image. By rotating the wave plate 21 from the position of not using polarizing sunglasses to the position of using polarizing sunglasses by 45 degrees, the projection light containing the P polarization component as a principal component is emitted from the polarization switching unit 20 toward the reflector 30. Due to this, the display device 1 for a vehicle can enable the occupant wearing polarizing sunglasses to visually recognize the virtual image.

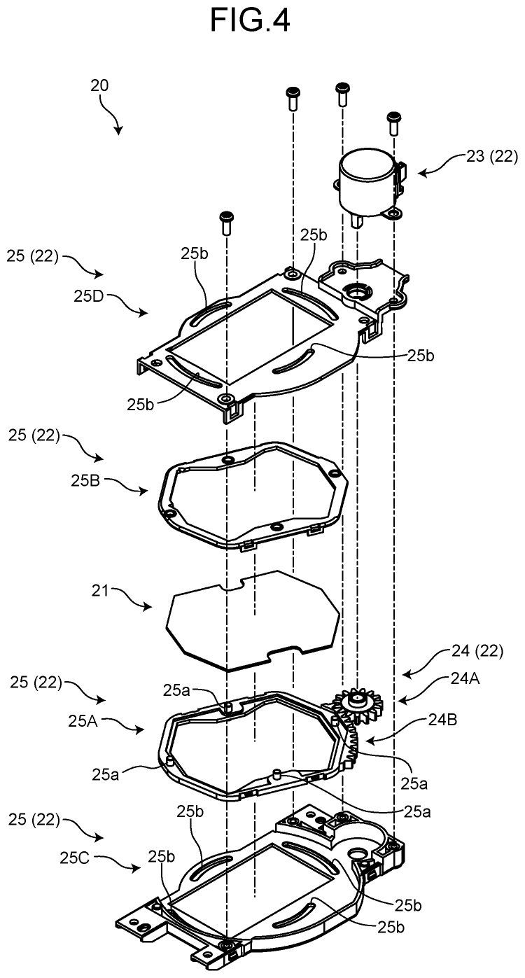

The drive device 22 uses, as a driving source, an electric motor 23 (FIG. 2 to FIG. 4) driven and controlled by the controller 40, and causes the wave plate 21 to rotate about a rotation axis orthogonal to a plane thereof (a plane on which the emission light of the display 10 is incident, a plane through which the incident light is transmitted to be emitted). The drive device 22 includes a power transmission mechanism 24 (FIG. 4) that transmits output torque of the electric motor 23 to the wave plate 21, and a holding mechanism 25 (FIG. 2 to FIG. 4) that holds a peripheral part of the wave plate 21 in a rotatable manner.

In the drive device 22 described herein, a stepping motor is used as the electric motor 23, and output torque thereof is transmitted to the wave plate 21 via a gear wheel group as the power transmission mechanism 24. The power transmission mechanism 24 includes a pinion gear 24A having a spur gear shape concentrically arranged on an output shaft of the electric motor 23, and a rack 24B arranged on a peripheral part of the wave plate 21 to be meshed with the pinion gear 24A (FIG. 4).

The holding mechanism 25 includes an annular first guide member 25A and an annular second guide member 25B that surround the peripheral part of the wave plate 21 in a circumferential direction, and a first holding member 25C and a second holding member 25D that hold the wave plate 21 in a rotatable manner via the first guide member 25A and the second guide member 25B (FIG. 2 to FIG. 4).

The first guide member 25A and the second guide member 25B are annular members that sandwich and hold the peripheral part of the wave plate 21 in a state of being assembled to each other, and expose both planes of the wave plate 21. At least one of the first guide member 25A and the second guide member 25B includes a cylindrical guide projection 25a arranged on a parallel axis with respect to the rotation axis of the wave plate 21 (FIG. 2 to FIG. 4). In the holding mechanism 25, a plurality of pairs of (herein, four pairs of) the guide projections 25a projecting in opposite directions on the parallel axis are disposed at intervals in a rotation direction of the wave plate 21. For example, the pair of guide projections 25a are cylindrical projections projecting in opposite directions from an annular main body of any one of the first guide member 25A and the second guide member 25B, and a plurality of the pairs thereof are disposed at intervals in the circumferential direction on each annular main body. For example, the pair of guide projections 25a are a cylindrical projection projecting from the annular main body of the first guide member 25A and a cylindrical projection projecting from the annular main body of the second guide member 25B in the opposite direction, and a plurality of the pairs thereof are disposed at intervals in the circumferential direction on each of the annular main bodies. Herein, all of the guide projections 25a are disposed on the first guide member 25A.

Herein, the rack 24B is disposed on a peripheral part of any one of the first guide member 25A and the second guide member 25B. The rack 24B may be formed integrally with the peripheral part of a main body of any one of the first guide member 25A and the second guide member 25B, or may be formed as a separate component to be fixed to the peripheral part thereof. Herein, the rack 24B is formed integrally with the peripheral part of the annular main body of the first guide member 25A as a portion of the first guide member 25A (FIG. 4).

The first holding member 25C and the second holding member 25D, which are assembled to each other, hold the wave plate 21 in a rotatable manner via the first guide member 25A and the second guide member 25B. The first holding member 25C and the second holding member 25D hold the first guide member 25A and the second guide member 25B in a rotatable manner while exposing both planes of the wave plate 21.

The first holding member 25C is formed as a housing member that houses and holds the wave plate 21, the first guide member 25A, and the second guide member 25B in a rotatable manner. The first holding member 25C described herein is caused to also house and hold the power transmission mechanism 24 in an operable manner. The second holding member 25D is like a cover member that covers an opening of the first holding member 25C while exposing the wave plate 21, and holds the wave plate 21, the first guide member 25A, and the second guide member 25B in a rotatable manner. The electric motor 23 is fixed to the second holding member 25D.

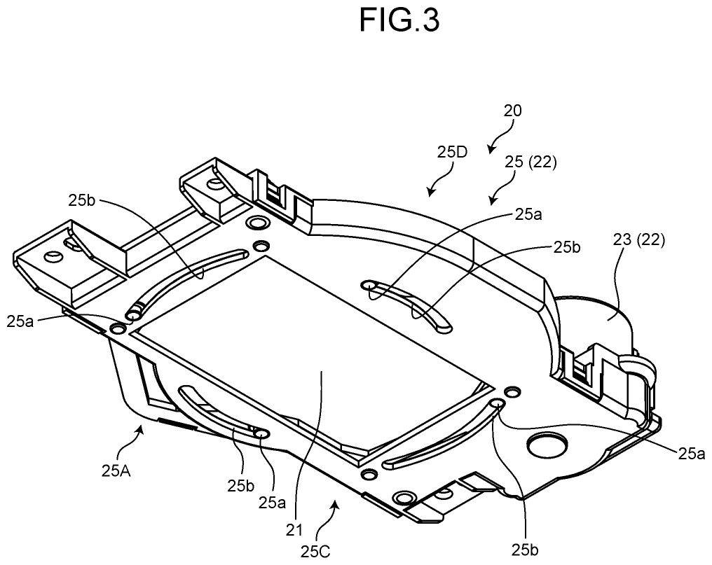

The first holding member 25C includes a guide rail 25b having a through hole shape or a groove shape that houses and guides one of the pair of guide projections 25a for each pair of the guide projections 25a (FIG. 2 and FIG. 4). Similarly, the second holding member 25D includes the guide rail 25b having a through hole shape or a groove shape that houses and guides the other one of the pair of guide projections 25a for each pair of the guide projections 25a (FIG. 3 and FIG. 4). The guide rail 25b described herein is formed in a through hole shape. At the time of rotating the wave plate 21 between the position of not using polarizing sunglasses and the position of using polarizing sunglasses, a pair of the guide rails 25b opposed to each other in an axial direction of the rotation axis of the wave plate 21 guides the pair of guide projections 25a along a rotation locus thereof.

The pair of guide projections 25a and the pair of guide rails 25b described herein are formed to be able to rotate the wave plate 21 at least between the position of not using polarizing sunglasses and the position of using polarizing sunglasses (that is, at least by 45 degrees) from one end to the other end of the guide rail 25b for each combination thereof.

In the polarization switching unit 20, the position of not using polarizing sunglasses is assumed to be an origin of the rotational position of the wave plate 21. For example, herein, the rotational position of the wave plate 21 at the time when the guide projection 25a is arranged at one end of the guide rail 25b is assumed to be the origin.

The controller 40 drives and controls the electric motor 23 of the drive device 22 depending on whether a required visual recognition mode is the mode of not using polarizing sunglasses or the mode of using polarizing sunglasses, and performs rotational position control for the wave plate 21. For example, the controller 40 determines that there is a switching command for the required visual recognition mode to the mode of not using polarizing sunglasses or the mode of using polarizing sunglasses based on a switching command signal for the required visual recognition mode caused by a switching operation for a required visual recognition mode switching switch by the occupant, a pressing operation or a touch operation for a required visual recognition mode setting button, and the like, and determines whether the required visual recognition mode is the mode of not using polarizing sunglasses or the mode of using polarizing sunglasses.

When a command is given to switch the required visual recognition mode to the mode of not using polarizing sunglasses or the mode of using polarizing sunglasses, the controller 40 supplies an exciting current to the electric motor 23 to rotate the wave plate 21 to the rotational position of the required visual recognition mode. When the required visual recognition mode is the mode of not using polarizing sunglasses, the controller 40 drives and controls the electric motor 23 of the drive device 22 to rotate the wave plate 21 to the position of not using polarizing sunglasses. Additionally, when the required visual recognition mode is the mode of using polarizing sunglasses, the controller 40 drives and controls the electric motor 23 of the drive device 22 to rotate the wave plate 21 to the position of using polarizing sunglasses.

Conventionally, irrespective of whether the required visual recognition mode is the mode of not using polarizing sunglasses or the mode of using polarizing sunglasses, the exciting current is continuously applied to the electric motor even after the wave plate is rotated to the position of not using polarizing sunglasses or the position of using polarizing sunglasses. Due to this, the conventional display device for a vehicle continuously consumes electric power while an ignition is in an ON state. Thus, when a command is given to switch the required visual recognition mode to the mode of not using polarizing sunglasses or the mode of using polarizing sunglasses, the controller 40 according to the present embodiment suppress increase in power consumption by supplying the exciting current to the electric motor 23 to rotate the wave plate 21 to the rotational position of the required visual recognition mode, and interrupting the exciting current flowing through the electric motor 23 thereafter. As described later, the controller 40 described herein interrupts the exciting current flowing through the electric motor 23 after a prescribed time has elapsed after rotating the wave plate 21 to the rotational position in the required visual recognition mode.

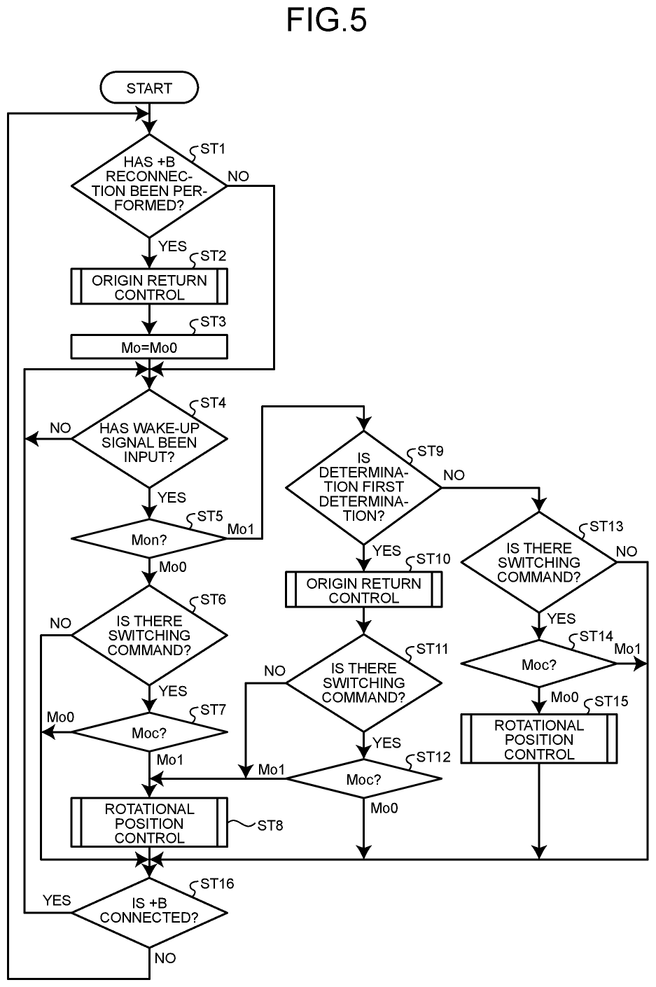

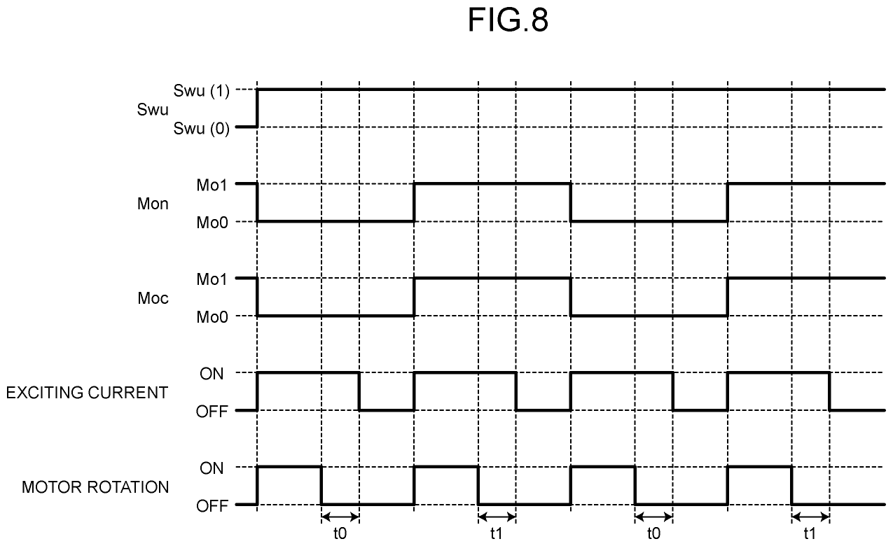

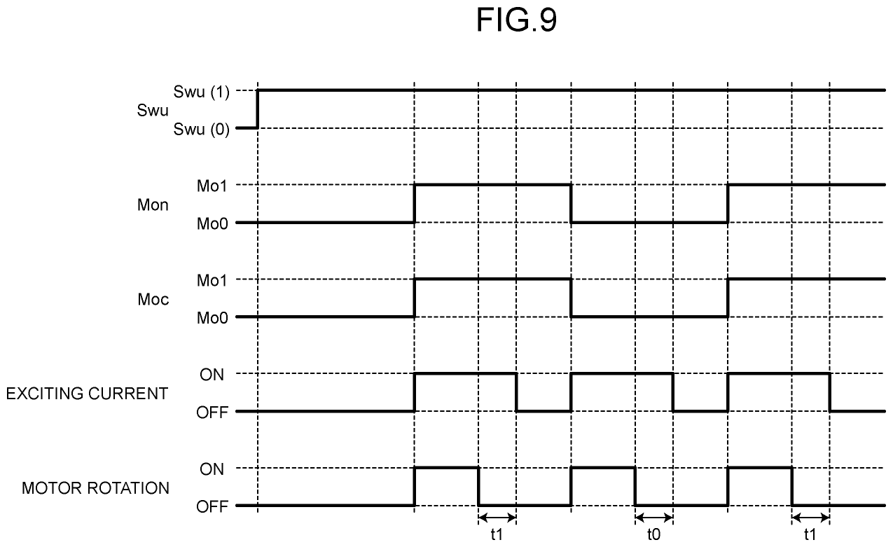

The following describes this control using the flowcharts in FIG. 5 to FIG. 7 and the time charts in FIG. 8 and FIG. 9.

As illustrated in the flowchart in FIG. 5, for example, when processing of restarting a system of the vehicle (wake-up processing at the time of restarting) is performed and a wake-up signal at the time of restarting is input from the vehicle side, the controller 40 determines whether reconnection (+B reconnection) of a positive electrode terminal of a storage battery of the vehicle has been performed (for example, whether the storage battery has been replaced) (Step ST1).

In a case in which +B reconnection has been performed such as a case in which the storage battery has been replaced, continuous power supply (+B) of the vehicle is temporarily disconnected, and various kinds of information (for example, information of the required visual recognition mode, information of the rotational position of the wave plate 21, and the like) recorded in a random access memory (RAM) of the controller 40 are deleted, for example. Thus, if such information does not remain in the RAM, the controller 40 determines that +B reconnection has been performed at Step ST1.

In this case, information of the rotational position of the wave plate 21 does not remain in the RAM, so that the controller 40 performs origin return control for returning the rotational position of the wave plate 21 to the origin (position of not using polarizing sunglasses) (Step ST2), and sets a required visual recognition mode Mo to be a mode of not using polarizing sunglasses Mo0 (Step ST3).

In this way, in the display device 1 for a vehicle, in the first control after +B reconnection, origin return control for the wave plate 21 is performed and the required visual recognition mode Mo is set to be the mode of not using polarizing sunglasses Mo0. The origin return control at Step ST2 will be described later in detail.

On the other hand, in a case in which +B reconnection has not been performed such that the storage battery has not been replaced, the continuous power supply (+B) of the vehicle is kept in a connected state, for example, and various kinds of information remain in the RAM of the controller 40. Thus, in a case in which a +B signal from the vehicle side is kept being input, or a case in which such information remains in the RAM, the controller 40 determines that +B reconnection has not been performed at Step ST1, and advances the process to the next Step ST4.

The controller 40 determines whether the wake-up signal has been input (Step ST4). The wake-up signal herein means, for example, a signal to be a trigger for starting an integrated controller (not illustrated) of the vehicle in a sleep state such as a door lock release signal input from a door key and the like. The controller 40 repeatedly performs this determination unless the wake-up signal is input. On the other hand, in a case in which the wake-up signal is input, the controller 40 reads a current required visual recognition mode Mon from the RAM, and determines whether the required visual recognition mode Mon is the mode of not using polarizing sunglasses Mo0 or a mode of using polarizing sunglasses Mo1 (Step ST5).

In a case of determining that the current required visual recognition mode Mon is the mode of not using polarizing sunglasses Mo0 at Step ST5, the controller 40 determines presence/absence of a switching command for the required visual recognition mode Mo (Step ST6).

In a case of determining that there is no switching command for the required visual recognition mode Mo at Step ST6, the controller 40 advances the process to Step ST16 described later. On the other hand, in a case of determining that there is the switching command for the required visual recognition mode Mo at Step ST6, the controller 40 determines whether the required visual recognition mode Moc of the switching command is the mode of not using polarizing sunglasses Mo0 or the mode of using polarizing sunglasses Mo1 (Step ST7).

In a case of determining that the switching command is a command for switching to the mode of not using polarizing sunglasses Mo0 at Step ST7, the current required visual recognition mode Mon is the mode of not using polarizing sunglasses Mo0, so that the controller 40 advances the process to Step ST16 described later. On the other hand, in a case of determining that the switching command is a command for switching to the mode of using polarizing sunglasses Mo1 at Step ST7, the controller 40 performs rotational position control for the wave plate 21 to the position of using polarizing sunglasses (Step ST8), and advances the process to Step ST16 described later. The rotational position control at Step ST8 will be described later in detail. The controller 40 rewrites the current required visual recognition mode Mon to the mode of using polarizing sunglasses Mo1 at Step ST8.

In a case of determining that the current required visual recognition mode Mon is the mode of using polarizing sunglasses Mo1 at Step ST5, the controller 40 determines whether the determination at Step ST5 is the first determination after inputting the wake-up signal (Step ST9).

In a case of determining that the determination is the first determination at Step ST9, the controller 40 performs the same origin return control as that at Step ST2 (Step ST10), and determines presence/absence of the switching command for the required visual recognition mode Mo thereafter (Step ST11).

In a case of determining that there is no switching command for the required visual recognition mode Mo at Step ST11, the controller 40 advances the process to Step ST8 because the rotational position of the wave plate 21 has been controlled to the origin (position of not using polarizing sunglasses) at Step ST10, performs rotational position control for the wave plate 21 to the position of using polarizing sunglasses, and advances the process to Step ST16 described later. On the other hand, in a case of determining that there is the switching command for the required visual recognition mode Mo at Step ST11, the controller 40 determines whether the required visual recognition mode Moc of the switching command is the mode of not using polarizing sunglasses Mo0 or the mode of using polarizing sunglasses Mo1 (Step ST12).

In a case of determining that the switching command is a command for switching to the mode of not using polarizing sunglasses Mo0 at Step ST12, the controller 40 advances the process to Step ST16 described later because the rotational position of the wave plate 21 has been already controlled to the origin (position of not using polarizing sunglasses) at Step ST10. On the other hand, in a case of determining that the switching command is a command for switching to the mode of using polarizing sunglasses Mo1 at Step ST12, the controller 40 advances the process to Step ST8 because the rotational position of the wave plate 21 has been controlled to the origin (position of not using polarizing sunglasses) at Step ST10, performs rotational position control for the wave plate 21 to the position of using polarizing sunglasses, and advances the process to Step ST16 described later.

In a case of determining that the determination is not the first determination at Step ST9, the controller 40 determines presence/absence of the switching command for the required visual recognition mode Mo (Step ST13).

In a case of determining that there is no switching command for the required visual recognition mode Mo at Step ST13, the controller 40 advances the process to Step ST16 described later. On the other hand, in a case of determining that there is the switching command for the required visual recognition mode Mo at Step ST13, the controller 40 determines whether the required visual recognition mode Moc of the switching command is the mode of not using polarizing sunglasses Mo0 or the mode of using polarizing sunglasses Mo1 (Step ST14).

In a case of determining that the switching command is a command for switching to the mode of not using polarizing sunglasses Mo0 at Step ST14, the controller 40 performs rotational position control for the wave plate 21 to the position of not using polarizing sunglasses (Step ST15), and advances the process to Step ST16 described later. The rotational position control at Step ST15 will be described later in detail. The controller 40 rewrites the current required visual recognition mode Mon to the mode of not using polarizing sunglasses Mo0 at Step ST15. On the other hand, in a case of determining that the switching command is a command for switching to the mode of using polarizing sunglasses Mo1 at Step ST14, the controller 40 advances the process to Step ST16 described later because the current rotational position of the wave plate 21 is the position of using polarizing sunglasses.

In this way, in a case in which the ignition is turned off in the mode of using polarizing sunglasses Mo1, when the wake-up signal (Swu) is input {Swu(0)→Swu(1)}, the controller 40 returns the rotational position of the wave plate 21 to the origin (position of not using polarizing sunglasses), and performs rotational position control for the wave plate 21 corresponding to the required visual recognition mode thereafter (FIG. 8). On the other hand, in a case in which the ignition is turned off in the mode of not using polarizing sunglasses Mo0, the controller 40 performs rotational position control for the wave plate 21 corresponding to the required visual recognition mode after the wake-up signal (Swu) is input {Swu(0)→Swu(1)} thereafter (FIG. 9).

The controller 40 determines whether the continuous power supply (+B) of the vehicle is kept in the connected state at Step ST16.

If the continuous power supply (+B) is not connected, the controller 40 returns the process to Step ST1, and stops the operation thereof until the wake-up signal at the time of restarting is input again from the vehicle side. If the continuous power supply (+B) is kept in the connected state, the controller 40 returns the process to Step ST4.

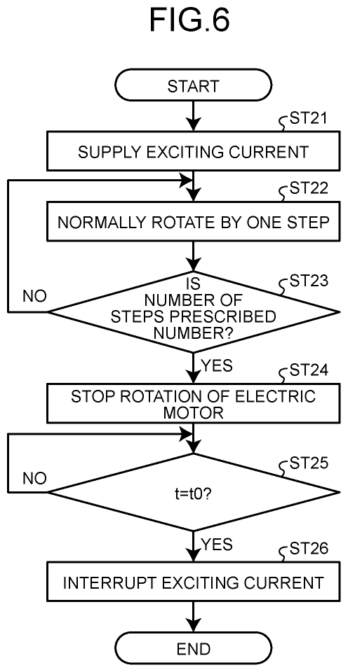

The flowchart in FIG. 6 illustrates the origin return control at Steps ST2 and ST10, and the rotational position control at Step ST15.

The controller 40 supplies an exciting current to a coil of the electric motor 23 (Step ST21), and causes the electric motor 23 to normally rotate by one step (Step ST22). Herein, by causing the electric motor 23 to normally rotate by a prescribed number of steps, the wave plate 21 can be rotated from the position of using polarizing sunglasses to the position of not using polarizing sunglasses. In this example, by causing the electric motor 23 to normally rotate by the prescribed number of steps, the guide projection 25a abuts on one end of the guide rail 25b to be locked, and the rotational position of the wave plate 21 reaches the origin (position of not using polarizing sunglasses).

Thus, the controller 40 determines whether the electric motor 23 has normally rotated by the prescribed number of steps (Step ST23). If the number of steps does not reach the prescribed number, the controller 40 returns the process to Step ST22, and repeatedly performs this process until the electric motor 23 normally rotates by the prescribed number of steps.

When the electric motor 23 normally rotates by the prescribed number of steps, the controller 40 stops the rotation of the electric motor 23 (Step ST24). The controller 40 then determines whether a time t elapsed after stopping the rotation of the electric motor 23 reaches a prescribed time t0 (Step ST25), and repeatedly performs this determination until the prescribed time t0 elapses. After the prescribed time t0 has elapsed, the controller 40 interrupts the exciting current flowing through the electric motor 23 (Step ST26).

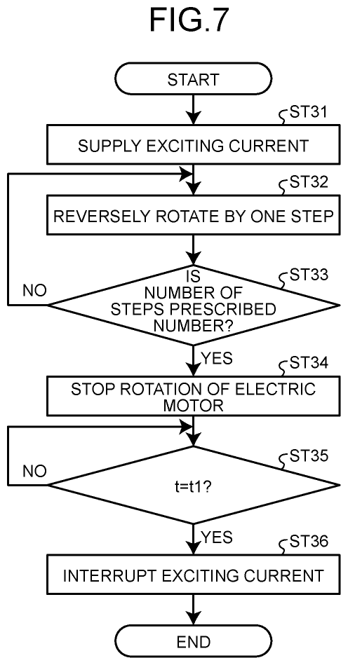

The flowchart in FIG. 7 illustrates the rotational position control at Step ST8.

The controller 40 supplies the exciting current to the coil of the electric motor 23 (Step ST31), and causes the electric motor 23 to reversely rotate by one step (Step ST32). The controller 40 determines whether the electric motor 23 has reversely rotated by the prescribed number of steps (Step ST33). If the number of steps does not reach the prescribed number, the controller 40 returns the process to Step ST32, and repeatedly performs this process until the electric motor 23 reversely rotates by the prescribed number of steps.

When the electric motor 23 reversely rotates by the prescribed number of steps, the controller 40 stops the rotation of the electric motor 23 (Step ST34). The controller 40 then determines whether the time t elapsed after stopping the rotation of the electric motor 23 reaches the prescribed time t1 (Step ST35), and repeatedly performs this determination until the prescribed time t1 elapses. After the prescribed time t1 has elapsed, the controller 40 interrupts the exciting current flowing through the electric motor 23 (Step ST36). The prescribed time t1 may be the same as the prescribed time t0 at Step ST25, or may be different therefrom.

As described above, in the display device 1 for a vehicle according to the present embodiment, an electric current is applied to the electric motor 23 only when the required visual recognition mode is switched to the mode of not using polarizing sunglasses or the mode of using polarizing sunglasses, so that increase in power consumption can be suppressed. In the display device 1 for a vehicle, in a case in which the ignition is turned off in the mode of using polarizing sunglasses, when the wake-up signal is input thereafter, the rotational position of the wave plate 21 is returned to the origin (position of not using polarizing sunglasses). However, such origin return control is not performed in a case in which the ignition is turned off in the mode of not using polarizing sunglasses, so that increase in power consumption can be suppressed. Additionally, in the display device 1 for a vehicle, the position of not using polarizing sunglasses is the origin of the rotational position of the wave plate 21, so that in a case in which the mode of not using polarizing sunglasses is designated as the required visual recognition mode after returning the wave plate 21 to the origin (position of not using polarizing sunglasses), the wave plate 21 is not required to be rotated, so that increase in power consumption can be suppressed.

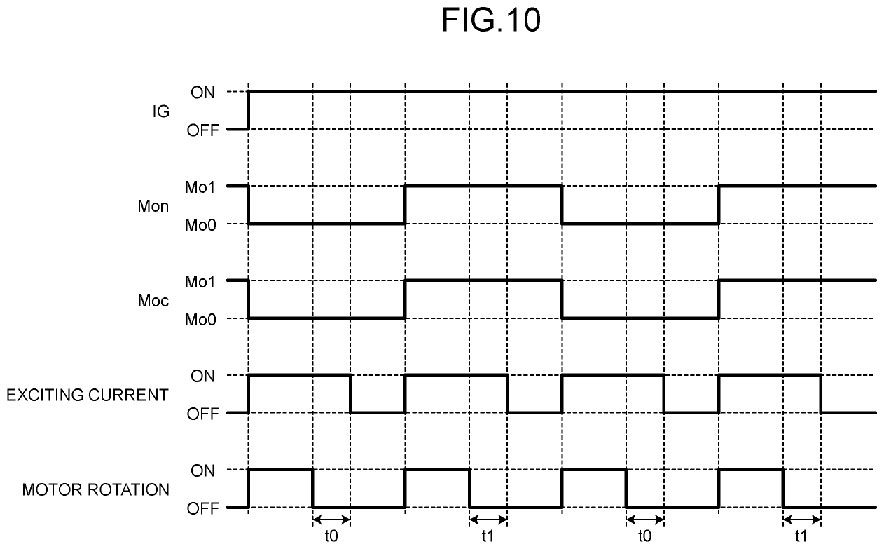

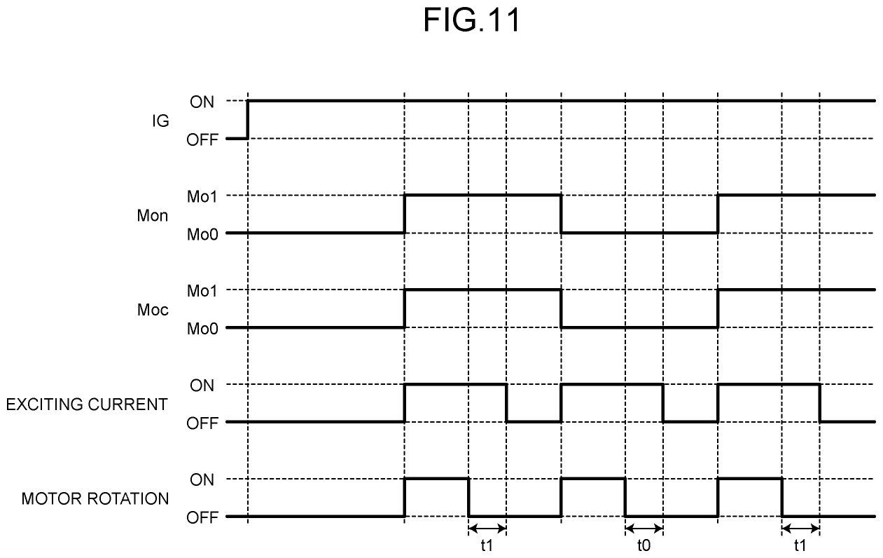

In the examples described above, the rotational position of the wave plate 21 is controlled triggered by input of the wake-up signal, but the rotational position may be controlled triggered by input of an ignition-on signal after the wake-up signal is input instead of input of the wake-up signal. That is, in a case in which the ignition is turned off in the mode of using polarizing sunglasses Mo1, and the ignition is turned on thereafter, the controller 40 returns the rotational position of the wave plate 21 to the origin (position of not using polarizing sunglasses), and performs rotational position control for the wave plate 21 corresponding to the required visual recognition mode thereafter (FIG. 10). On the other hand, in a case in which the ignition is turned off in the mode of not using polarizing sunglasses Mo0, the controller 40 performs rotational position control for the wave plate 21 corresponding to the required visual recognition mode after the ignition is turned on thereafter (FIG. 11). The display device 1 for a vehicle according to the present embodiment can exhibit the same effect as that in a case in which the control is performed triggered by input of the wake-up signal even when the control is performed triggered by input of the ignition-on signal as described above.

In the display device for a vehicle according to the present embodiment, an electric current is applied to an electric motor only when a required visual recognition mode is switched to a mode of not using polarizing sunglasses or a mode of using polarizing sunglasses, so that increase in power consumption can be suppressed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display device for a vehicle, the display device comprising:
a display configured to emit, as display light, display information to be visually recognized as a virtual image by an occupant in a compartment;
a polarization switching unit configured to emit emission light from the display while switching a polarization direction between a mode of not using polarizing sunglasses in which the occupant is not using polarizing sunglasses and a mode of using polarizing sunglasses in which the occupant is using polarizing sunglasses;
a reflector configured to directly or indirectly receive the emission light from the polarization switching unit, and reflect the emission light toward an eye box as a visible range for a virtual image of the occupant; and
a controller configured to control operation of the display and the polarization switching unit, wherein
the polarization switching unit includes: a wave plate configured to be able to emit emission light of the display while changing a polarization direction; and a drive device using an electric motor driven and controlled by the controller as a driving source and configured to be able to rotate the wave plate between a position of not using polarizing sunglasses in the mode of not using polarizing sunglasses and a position of using polarizing sunglasses in the mode of using polarizing sunglasses, causes transmitted light containing an S polarization component as a principal component to be emitted from the wave plate at the position of not using polarizing sunglasses, and causes transmitted light containing a P polarization component as a principal component to be emitted from the wave plate at the position of using polarizing sunglasses, and,
when a command is given to switch a required visual recognition mode to the mode of not using polarizing sunglasses or the mode of using polarizing sunglasses, the controller supplies an exciting current to the electric motor to rotate the wave plate to a rotational position in the required visual recognition mode, and interrupts the exciting current flowing through the electric motor thereafter.

2. The display device for a vehicle according to claim 1, wherein the controller interrupts the exciting current flowing through the electric motor after a prescribed time has elapsed after rotating the wave plate to a rotational position in the required visual recognition mode.

3. The display device for a vehicle according to claim 1, wherein, in a case in which an ignition is turned off in the mode of using polarizing sunglasses, when a wake-up signal is input thereafter, the controller returns the rotational position of the wave plate to an origin, and performs rotational position control for the wave plate corresponding to the required visual recognition mode.

4. The display device for a vehicle according to claim 2, wherein, in a case in which an ignition is turned off in the mode of using polarizing sunglasses, when a wake-up signal is input thereafter, the controller returns the rotational position of the wave plate to an origin, and performs rotational position control for the wave plate corresponding to the required visual recognition mode.

5. The display device for a vehicle according to claim 3, wherein the origin of the rotational position of the wave plate is the position of not using polarizing sunglasses.

6. The display device for a vehicle according to claim 4, wherein the origin of the rotational position of the wave plate is the position of not using polarizing sunglasses.
